(19) United States
(12) Patent Application Publication
(10) Pub. No.: US 2008/0309765 A1
(43) Pub. Date: Dec. 18, 2008

(54) PORTABLE WIRELESS BABY MONITOR

(76) Inventors: Maurice S. Dayan, Oakhurst, NJ (US); Mervin A. Dayan, Oakhurst, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 12/033,757

(22) Filed: Feb. 19, 2008

Related U.S. Application Data
(60) Provisional application No. 60/890,225, filed on Feb. 16, 2007.

(51) Int. Cl. H04N 7/18

(52) U.S. Cl. 348/158; 348/E07.085

(57) ABSTRACT

A method and system for monitoring, both audibly and visually, a child in any location. The method and system consists of providing a wireless camera that can conveniently be located both in a vehicle and in the home. The wireless camera transmits the image signal to a monitor that can be mounted within a vehicle or placed within the home. The monitor may be charged via a 12 V adapter, or by using a home base unit. The camera may have infrared sensors in order to see in dark conditions.

### CROSS REFERENCE TO RELATED APPLICATIONS

The present invention claims the benefit of U.S. Provisional Application Ser. No. 60/890,225 filed on Feb. 16, 2007, the entirety of which is hereby incorporated by reference.

### FIELD OF THE INVENTION

This invention relates to the field of devices for monitoring a person. In particular, the invention relates to a system and method for monitoring a child in a vehicle and in the home from a remote location.

### BACKGROUND OF THE INVENTION

In the past various devices have been used for monitoring babies. Past baby monitors have relied upon sound in order to alert a parent that their child was crying or in distress. These devices have typically been used in the home and consisted of a sound transmitter for broadcasting the baby's cry to a sound receiver.

It has also been important for parents to monitor their children while driving. Because an infant's seat is placed facing the rear of the vehicle for extra protection, it is often difficult to determine if the infant is in distress. In the past, mirrors have been mounted in the rear seat of a vehicle in order to view the baby through the rear view mirror.

Although the various devices and methods discussed above provide a parent or guardian with a way of monitoring their child, there is no convenient way to monitor a child both visually and audibly in the vehicle and the home.

Therefore there remains a need in the field to provide both an apparatus and method for monitoring, both audibly and visually, a child in any location.

### SUMMARY OF THE INVENTION

It is therefore an object of the invention to provide a system and method for monitoring a child.

Another object of the invention is to provide a system for monitoring a child in both a vehicle and in the home.

Yet another object of the invention is to provide a camera that is capable of perceiving images in low light conditions.

Yet another object of the invention is to provide a camera that is capable of being adjustably positioned and mounted.

Another object of the invention is to provide a system that reproduces both image information and audio information.

In accordance with these and other objects of the invention, a first aspect of invention can be a portable system for observing a person comprising: an adjustable strap; a camera assembly comprising: (i) a camera adapted to produce an image signal corresponding to a perceived image, (ii) a bracket having at least one slot for operably receiving the adjustable strap so that the adjustable strap forms a loop, and (iii) a transmitter for wirelessly transmitting the image signal; a display device comprising: (i) a receiver for receiving the wirelessly transmitted image signal, and (ii) means for converting the received image signal into a display image that is displayed on the display device; a stand adapted to support the display device; and a base unit adapted to receive the display device, the base unit having means for supplying power to the display device.

In another aspect the invention can be a portable system for observing a person comprising: an adjustable strap comprising a first end having a stopper and a second end having a plurality of holes; a camera assembly comprising: (i) a camera adapted to produce an image signal corresponding to a perceived image, (ii) a bracket having at least one slot for operably receiving the adjustable strap so that the adjustable strap forms a loop, (iii) a locking mechanism for locking the strap, and (iv) a transmitter for wirelessly transmitting the image signal; wherein the adjustable strap is inserted through the slot so that the stopper is in contact with the bracket and the locking mechanism is inserted through the hole; a display device comprising: (i) a receiver for receiving the wirelessly transmitted image signal, and (ii) means for converting the received image signal into a display image that is displayed on the display device; a stand adapted to support the display device; and a base unit adapted to receive the display device, the base unit having means for supplying power to the display device.

In another aspect the invention can be a method for remotely observing a person in various locations using a portable system comprising: providing a camera assembly in a first room in a position within an image capturing range of a person, wherein the camera assembly has a transmitter for transmitting image and audio signals and a bracket having a slot; securing the camera assembly to a post by inserting a first end of a strap through the slot wrapping the strap around the post so as to form a loop around the post and securing the first end of the strap to a locking mechanism; providing a display device having a receiver for receiving the image signal; positioning the display device within viewing range of a second person.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows the components used with the system and method in accordance with one embodiment of the present invention.

FIG. 2 is a front perspective view of the camera in accordance with the embodiment shown in FIG. 1.

FIG. 3 is a front view of the camera in accordance with the embodiment shown in FIG. 2.

FIG. 4 is a rear view of the camera in accordance with the embodiment shown in FIG. 3.

FIG. 5 is a front perspective view of the display device mounted within the stand in accordance with the embodiment shown in FIG. 1.

FIG. 6 is a view of the stand used with the display device in accordance with the embodiment shown in FIG. 5.

FIG. 7A is a view of the display device mounted within a base unit in accordance with the embodiment shown in FIG. 1.

FIG. 7B is a view of the rear portion of the base unit in accordance with the embodiment shown in FIG. 7A.

FIG. 8 is a top perspective view of a strap in accordance with one embodiment of the present invention

FIG. 9 is a front view of the camera mounted within a vehicle in accordance with one embodiment of the present invention.

FIG. 10 is a front view of the camera and straps for mounting the camera in accordance with one embodiment of the present invention.

FIG. 11 is a view of the display device mounted within the vehicle, in accordance with one embodiment of the present invention.

FIG. 12A is a view of the camera mounted on a crib in accordance with one embodiment of the present invention.

FIG. 12B is a view of the display device mounted within a base unit in accordance with one embodiment of the present invention.

### DETAILED DESCRIPTION OF THE DRAWINGS

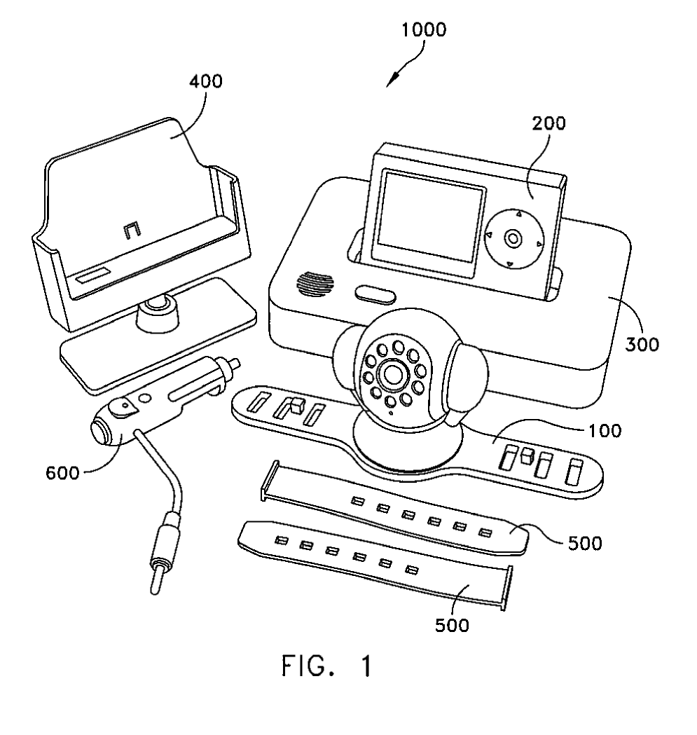

Referring to FIG. 1, a monitoring system 1000 in accordance with one embodiment of the present invention is illustrated. The monitoring system 1000 generally comprises a camera assembly 100, a display device 200, a base unit 300 and a stand 400. The monitoring system 1000 is designed to monitor a child in a vehicle and/or in a home or other dwelling. The operator and/or a passenger of the vehicle will be able to view a child riding in the rear passenger compartment of the vehicle. Additionally, a person in a first room of the home can monitor a child located in a second room within the home. While the monitoring system 1000 will be described throughout this application in relation to viewing a child in a vehicle or a crib, it is to be understood that the invention can be used to view a person in any other location, if desired. The individual components of the monitoring system 1000 are discussed in greater detail below.

The monitoring system 1000 is a portable system because the camera assembly 100 and the display device 200 are designed to be easily installed and removed from various locations including in a passenger compartment of a vehicle and in a home. In one embodiment, the monitoring system includes the camera assembly 100, the display device 200, the base unit 300, the stand 400, a pair of straps 500 for securing the camera assembly 100 to a post or other component within the passenger compartment of a vehicle and a 12V cigarette lighter adaptor 600 for supplying power to the display device 200 when the display device is in a vehicle. The stand 400 may remain in the vehicle while the base unit 300 may remain in the home. The display device 200 may be moved from the stand 400 to the base unit 300 and vice versa. The camera assembly 100 may be secured inside the passenger compartment of the vehicle when the display device is in the stand 400 for monitoring a child in the passenger compartment of the vehicle. The camera assembly 100 may then be moved to a first room in the home while the display device 200 is moved to the base unit 300 in a second room of the home for monitoring the child in the home.

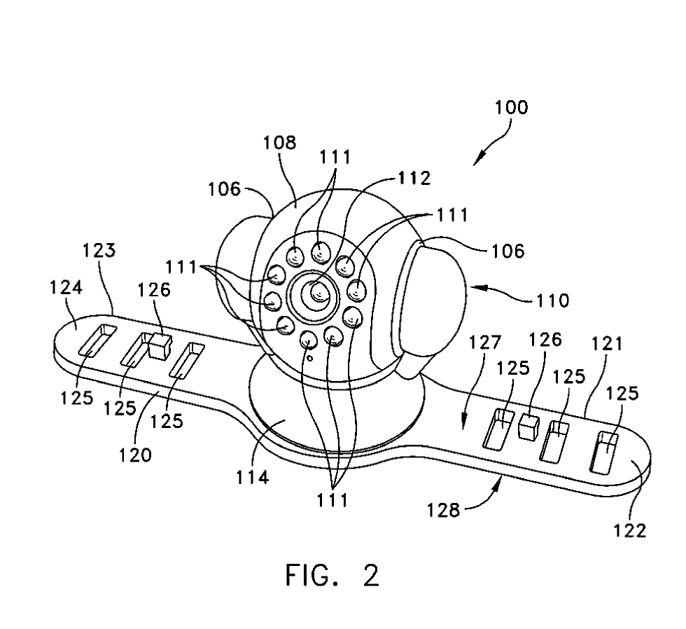

Referring now to FIG. 2, the structural aspects of the camera assembly 100 according to one embodiment of the present invention will be described in detail. With the exception of certain minor details, the camera assembly 100 is a symmetric structure with respect to both its horizontal and vertical axes. Generally, the camera assembly 100 comprises a camera portion 110 and a bracket 120. As will be discussed in greater detail below, the bracket 120 is provided so that so that the camera assembly 100 can be mounted to a desired component within a passenger compartment of a vehicle or within a child's crib in a home. Additionally, the camera portion 110 is removable from the bracket 120 so that the camera portion 110 may be placed on a surface in a home or other location while the bracket 120 remains in the vehicle or on the crib.

The bracket 120 comprises a top surface 127, a bottom surface 128, a first elongated flange 121 forming a first end 122 and a second elongated flange 123 forming a second end 124. The elongated flanges 121, 123 extend from the camera portion 110 in opposite directions. Stated another way, the flanges 121, 123 extend in a lengthwise direction from the camera portion 110 at approximately 180° apart from one another. The elongated flanges 121, 123 can be formed from a single elongated plate or from separate plates assembled to one another and/or the camera portion 110. The camera portion 110 is positioned equidistant from each of the ends 122, 124 and is removably connected on the top side 127 of the bracket 120. Each flange 121, 123 comprises a plurality of slots 125 extending through its major face (from the top surface 127 to the bottom surface 128). More specifically, each flange 121, 123 comprises three slots 125. The invention is not so limited however, and more or less slots 125 could be provided. The slots 125 are spaced an approximately equal distance from the camera portion 110 and an approximately equal distance from the ends 122, 124 of the flanges 121, 123. The camera portion 110 is positioned equidistant from the slots 125 on either side of it.

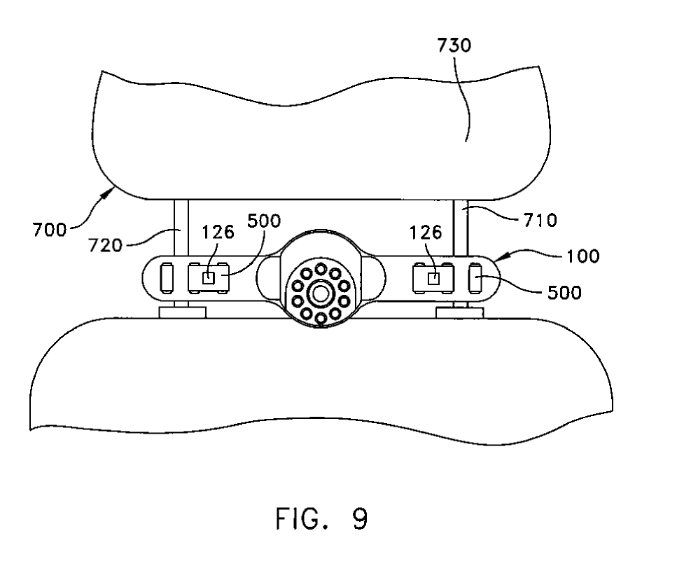

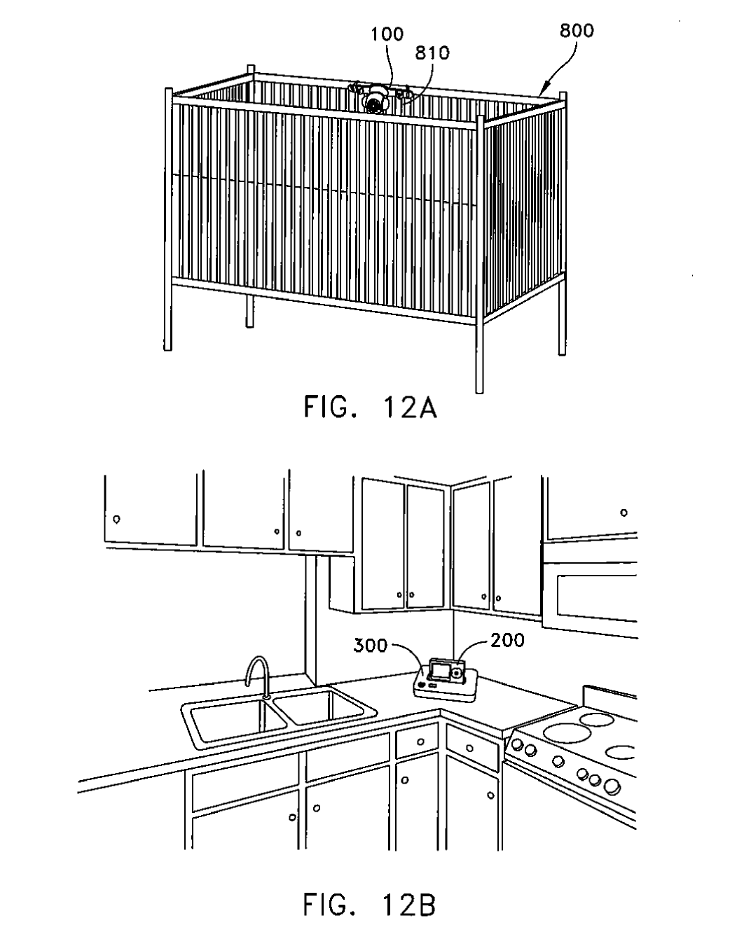

The slots 125 are located and designed to be used in combination with the straps 500 (shown in FIG. 1) to secure the camera assembly 110 to either a post of a vehicle's head rest (as shown in FIG. 9), a post of a child's crib (as shown in FIG. 12A) or any similar object such as a rail of a safety gate, a leg of a playpen and the like. A post can be any object or structure. Specifically, the slots 125 are separated form one another by a linear distance that corresponds to the standard linear distance between the posts of a head rest or the posts of a crib, etc. There are multiple slots 125 in each flange 121, 123 because the linear distance between posts may vary. The slots 125 are preferably rectangular shaped to correspond with the shape of the straps 500 (shown in FIG. 1). Of course, the slots 125 may have other geometric shapes depending upon the respective needs of the attachment devices and the hardware used.

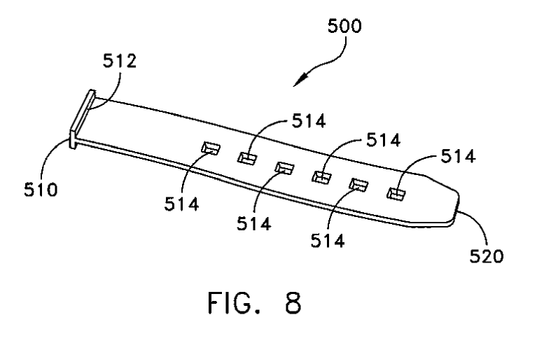

The bracket 120 further comprises a pair of tangs 126. One tang 126 is positioned on each flange 121, 123 on the top surface 127 of the bracket 120. As will be discussed in more detail below each tang 126 is designed to fit within a hole 514 of the strap 500 (shown in FIG. 8) to secure the strap 500 in place. The placement of the camera assembly 100 using the straps 500 is discussed in further detail below with respect to FIGS. 9 and 12A.

The camera portion 110 is centrally located on the bracket 120. The camera portion comprises a truncated spherical shaped housing 108 with two generally flat sides 106 and a base 114. It should be understood that the shape and size of the housing 108 is not limited to being spherical in shape and that other shapes may be used as desired. The housing 108 encloses and protects all of the necessary electrical components (including the camera (not visible), a transmitter (not illustrated), a image/audio signal processor and all of the internal circuitry to achieve the functions of the monitoring system 1000 discussed in this application). The camera of the camera portion 110 is able to transmit image signals to the display device 200 using the transmitter.

Located on the housing 108 is the lens 112 through which the camera perceives the images that are used to create image signals. The lens 112 encloses an opening in which the camera is located. The camera portion 110 is also capable of transmitting audio signals that it perceives through a microphone (not shown) as well. The transmitter typically will broadcast signals at 2.4 GHz, however it is possible to transmit audio and image signals at different frequencies. Finally, the camera is adapted to be infrared sensitive to capture images in total darkness or low-light conditions. A series of infrared (IR) LED (light emitting diode) lamps 111 surround the lens 112 in an annular pattern. The infrared LED lamps 111 permit the camera to perceive images in darkness.

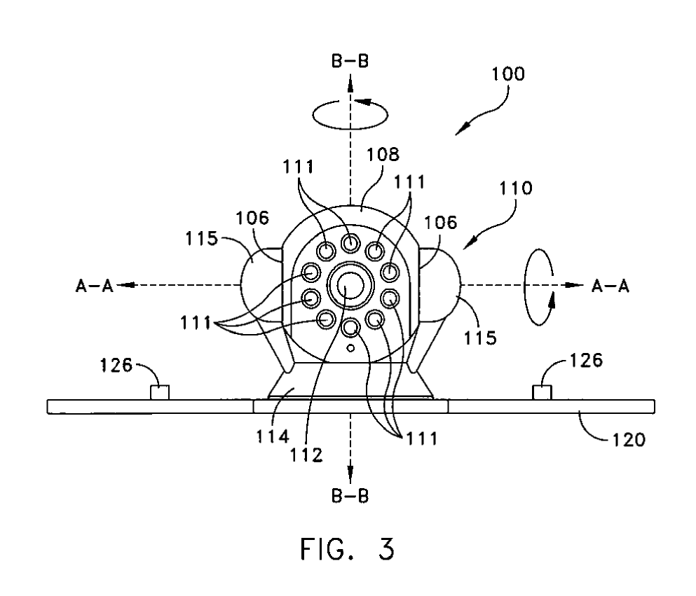

Referring to FIG. 3, the camera portion 110 is mounted on the bracket 120 so that the housing 108 may be rotated about an axis A-A that is substantially perpendicular to the longitudinal axis of the bracket 140. The camera portion 110 is designed to also be rotated about an axis B-B that is perpendicular to the longitudinal axis of the bracket 120. The rotation is shown by the curved arrows on the axes A-A and B-B. To facilitate rotation about the axis A-A, extending from the sides 106 of the housing 108 are rotation holders 115. The rotation holders 115 are placed on opposite sides of the housing 108 and permit rotation about the axis A-A that is defined by the line that would pass through the center of the two rotation holders 115. The rotation holder 115 encloses a ball joint or any other type of pivoting joint that permits rotation of the camera portion 110. The rotation holders 115 are connected to the base 114. The base 114 is connected to the bracket 120 so that it is rotatable about its central axis B-B. This permits the camera portion 110 to be adjusted both in a vertical and horizontal direction in order to more advantageously view a child depending upon where the camera assembly 100 is mounted. The camera portion 110 is removable from the bracket 140 so that the camera portion 110 may be supported by the base 114 which may rest upon a surface, such as a bookcase, shelf, dresser, floor, and the like.

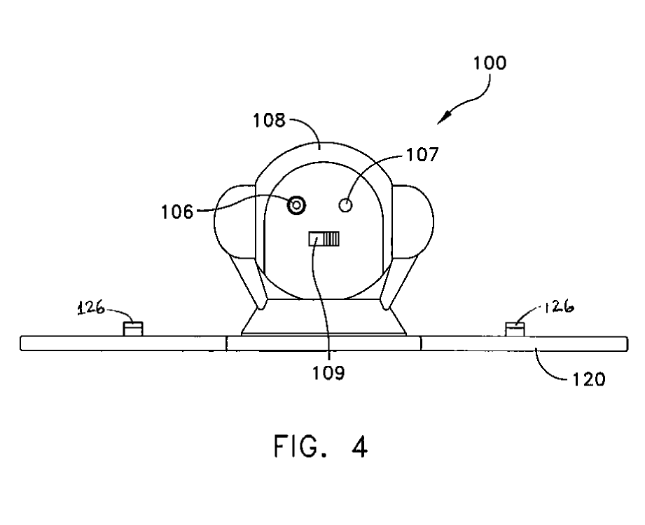

Referring now to FIG. 4, a rear view of the camera assembly 100 is illustrated. The camera assembly 100 further comprises on a rear of the housing 108 a power indicator light 107 that indicates whether or not the camera of the camera assembly 100 is operating. A socket 106 is also present in order to receive a 12 V adapter, like the cigarette Lighter adapter 600 shown in FIG. 1, to provide power to charge the camera of the camera assembly 100. The camera of the camera assembly 100 may also be charged by being wired to the vehicle's electrical system or through using batteries. A switch 109 is operably connected to a transmitter and permits the camera of the camera assembly 100 to be switched between a variety of channels on which it can transmit the image and/or audio signals. The switch 109 may also be switched to an off position in order to prevent transmission.

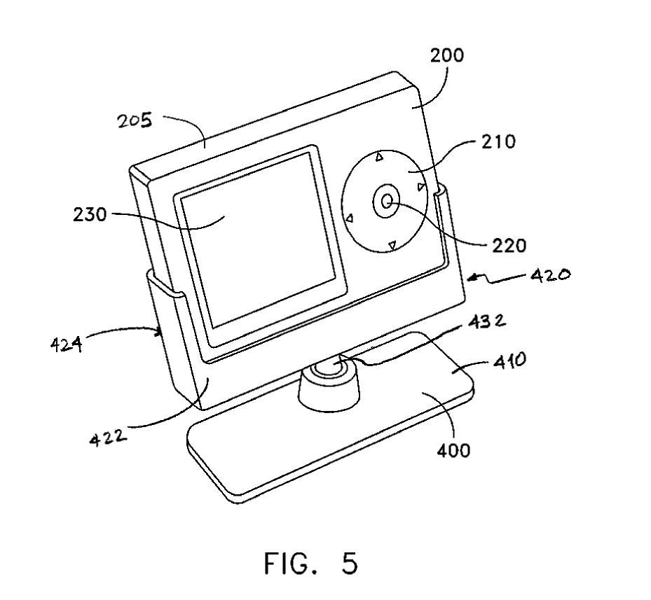

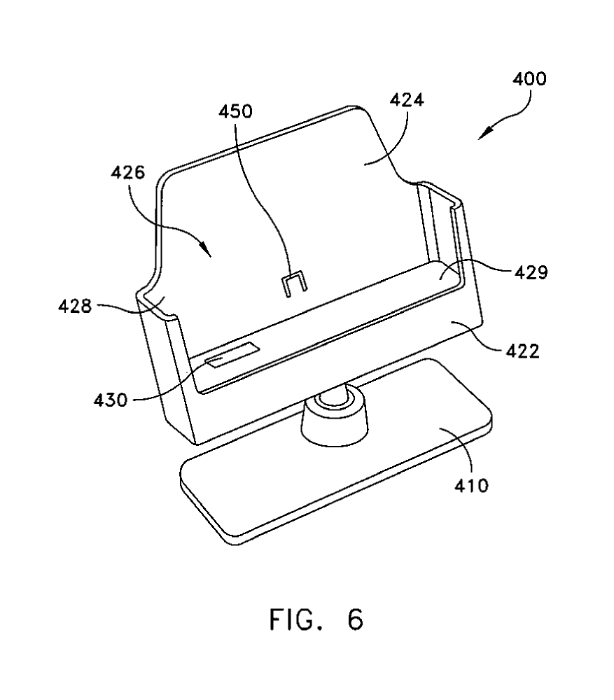

Referring now to FIGS. 5 and 6, the structural and functional details of the display device 200 and the stand 400 will be described. A front view of the display device 200 mounted within the stand 400 is shown in FIG. 5. The display device 200 is a compact structure that is designed to be placed within a passenger compartment of a vehicle at a location visible by the operator of the vehicle. The display device 200 comprises a housing 205 which acts as the main body of the display device 200. The circuitry and electrical components that enable the operation, functioning and control of the display device 200 are located within the housing 205.

The display device 200 comprises a screen 230 on which images received from the camera of the camera assembly 100 are displayed. The screen 230 used in the present invention is a 2.5 inch TFT-LCD screen, however other sizes and types of screens may be used. The display device 200 has located on its front a control panel 210 and a power indicator 220. The control panel 210 may have buttons corresponding to a number of functions such as channel switch, contrast, brightness and power on/off. While the control panel 210 is exemplified as a wheel, other control mechanisms may be used to operate and/or control the monitoring system 1000, including without limitation, knobs, switches, touch screen, etc.

Located within the display device 200 is a controller that handles and process the signals received from the transmitter. The controller is also operably connected to the control panel 210 and processes the control commands. A receiver located within the display device 200 receives the signals transmitted from the camera of the camera assembly 100.

Generally, the stand 400 comprises a stand base 410 and a support structure 420. The support structure 420 is pivotably connected to the stand base 410 via a swivel member 432, which is in the form of a ball joint. In other embodiments the swivel member 432 may be an axel-like pivot structure or any other type of pivoting joint.

The support structure 420 of the stand 400 is a sleeve-like structure adapted to receive and support the display device 200. The support structure comprises a front wall 422, a rear wall 424, a cavity 426 between the front wall 422 and the rear wall 424 and an open top end 428 forming a passageway into the cavity 426. The passageway is dimensioned so that the display device 200 can be slidably inserted into the cavity 426 through the passageway, thereby supporting the display device 200 in an upright position for viewing (as shown in FIG. 5).

The stand 400 further comprises a cutout 429 in the front wall 422. The cutout 429 is dimensioned and configured to allow unobstructed viewing of the display screen 230 of the display device 200 when the display device 200 is positioned in the cavity 426 and supported by the support structure as shown in FIG. 5. The cutout 429 also serves to allow access to the control panel 210 of the display device 200. Also located on the stand 400 is an engagement member 430 that may be inserted into the base of the display device 200. It is also possible to have the display device 200 mounted within the stand 400 without the engagement member 430 shown, or through the usage of other retaining means, e.g. snaps, straps, hook and loop tape, etc.

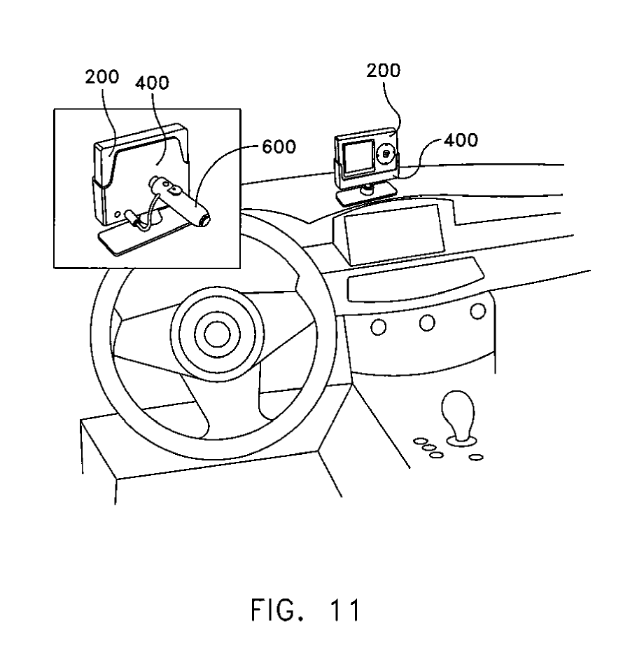

Located on the rear wall 424 of the support structure 420 is an attachment area 450 that permits the 12 V adapter, such as cigarette lighter adapter 600 (shown in FIG. 1) to be attached to the stand 400 and for energy to be provided to the display device 200, this is shown in more detail in FIG. 11 below. The attachment area 450 is aligned with and provides access to a power supply port on the display device 200. Depending on the number and location of ports and/or controls located on the display device 200, one or more attachment areas, cutouts and/or openings may be provided and suitably located on the support structure 420 so as to provide access to the ports and/or controls when the display device 200 is positioned within the cavity 426.

The stand 400 further comprises means for attaching the stand 400 to a surface in the passenger compartment of a vehicle. For example, the stand base 410 could have hardware like fasteners, screws, bolts, and the like for attachment to a dashboard, or an adhesive that connects the stand base 410 to a dashboard of a vehicle. Alternatively, a hook-and-loop fastener tape or other similar types of materials may be used in combination with the dashboard and the bottom of the stand base 410 to connect them together. Either the hook tape or the loop tape is attached to the stand base 410. This permits the stand 400 to be easily placed and removed from the interior of the vehicle. While the illustrated embodiment of the stand 400 is a sleeve-like structure, the invention is not so limited in other embodiments, the stand 400 can take on a wide variety of shapes, sizes and structural arrangements so long as it is capable of supporting the display device 200.

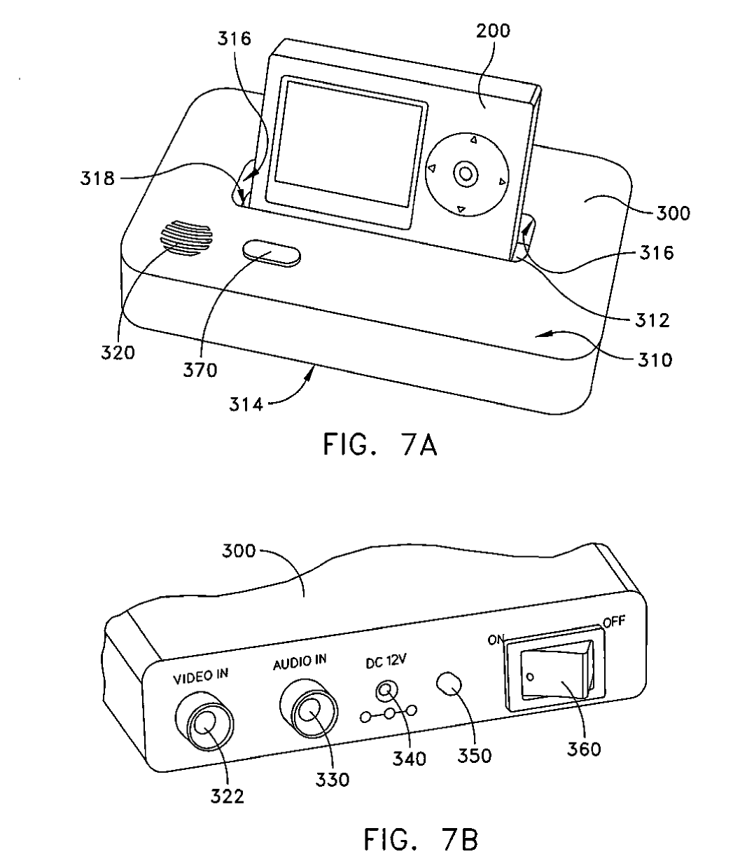

Referring to FIG. 7A, a view of the display device 200 mounted within a base unit 300 is shown that is in accordance with the embodiment of the system shown in FIG. 1. The base unit 300 is adapted to receive the display device 200 and can receive signals generated from the display device 200 and a bottom surface 314. It is also possible in some embodiments for the base unit 300 to receive signals from the camera of the camera assembly 100 as well as from the display unit 200. The base unit 300 comprises a top surface 310, a bay 312 adapted to support the display device 200 and bottom surface 314. The bay 312 is sized and shaped so as to receive and support the display device 200. The bay 312 is a rectangular shaped indentation in the top surface 310 of the base unit 300. The bay 312 extends into the body of the base unit only partially. The bay 312 does not extend through the entire height of the base unit 300. The bay 312 comprises inner surfaces 316 forming a cavity 318. The cavity 318 is sized and shaped to be slightly larger than the display device 200. There is a small clearance between the perimeter of the display device 200 and the inside edges 316 of the bay 312. The clearance is preferably less than 1 inch.

Located on the base unit 300 is a speaker 320 and a volume adjuster 370. The base unit 300 permits the monitoring system 1000 to provide information from the signals that it receives. In particular, the base unit 300, is adapted to receive audio signals either via cables or through a receiver located within and to broadcast the audio information through the speaker 320.

FIG. 7B shows a view of the rear portion of the base unit 300 in accordance with the embodiment shown in FIG. 7A. The base unit 300 may have located on its back portion a 12 V socket 340, an image input 320 for receiving video cables, an audio input 330 for receiving audio cables, a power indicator 350 and an on/off switch 360. There may also be a socket provided for a 110 V AC adapter. The base unit 300 may receive image and audio signals directly from the camera of the camera assembly 100 or through the display device 200. In embodiments where these inputs are on the base unit 300, the corresponding outputs are located on the display device 200. It is also contemplated that the base unit 300 has plugs that are able to be inserted into the display device 200 and to provide it with energy and/or reenergize a rechargeable battery located within the display device 200.

Alternatively, the 12 V socket 340, the video input 322, the audio input 330, the power indicator 350 and the on/off switch 360 may be located on a side of the display device 200. In the event that this is the case the corresponding outputs may be placed upon the base unit 300 or other corresponding component.

In the exemplified embodiment, the monitoring system 1000 further comprises a 12 volt power adapter 600 for supplying power to the display device 200. The 12 volt power adapter 600 is a flexible power wire comprising a first end having a cigarette lighter plug and a second end having a standard male jack for inserting into the female power supply port of the display device 200. Of course, other power supply wires and apparatus can be used, including batteries.

Referring now to FIG. 8, a strap 500 to be used in conjunction with the camera assembly 100 for securing the camera assembly 100 to a post or other similar component is shown. The strap 500 comprises a first end 510 and a second end 520. The first end 510 has a stopper 512 that keeps the strap 500 from pulling through the slot 125 of the bracket 120 (shown in FIG. 2). The stopper 512 is slighter larger than the slot 125 so that it cannot pass through the slot 125. The strap 500 further comprises a plurality of holes 514. The holes 514 are designed to engage with a locking mechanism like the tangs 126 of the bracket 120. More specifically, the tang 126 can fit through the hole 514 and then a protrusion on the tang 126 does not allow the strap 500 to be unintentionally removed from the tang 126 without the use of force. The invention is not so limited, and other locking mechanisms may be used however, including various hardware components like bolts, clips, brackets, etc and other locking mechanisms like adhesives including adhesive tape, velcro, and the like. Eight holes 514 are shown in FIG. 8. The invention is not so limited, however, and more or less holes 514 may be used. The holes 514 provide for adjustment of the strap 500 when it is being used with the camera assembly 100.

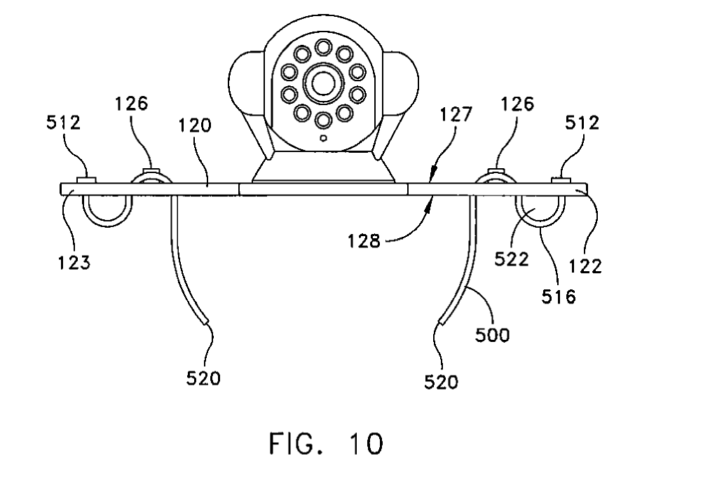

Referring to FIGS. 2, 8, 9 and 10 a method of securing the camera assembly 100 to the head rest 700 in a vehicle will now be discussed. A front view of the camera assembly 100 mounted within a vehicle in accordance with the embodiment of FIG. 1 is shown in FIG. 9. The straps 500 are used in conjunction with the slots 125 and the bracket 120 in order to secure the camera assembly 100 to the head rest portion 700 of a vehicle. The camera assembly 100 is positioned adjacent the head rest 700. The second end 520 of a first strap 500 is inserted through the slot 125 from the top surface 127 of the bracket 120 so that the second end 520 protrudes through the rear side 128 of the bracket 120. The stopper 510 comes into surface contact with the bracket 120 so that the first end 510 of the strap 500 cannot pass through the slot 125. The strap 500 is then wrapped around a post 710 of the head rest 700. The second end 520 of the strap 500 is then inserted through a second slot 125 from the bottom surface 128 of the bracket 120 so that the second end 520 protrudes from the top surface 127 of the bracket 120. A loop 516 is formed. The loop 516 forms an opening 522 in which the post 710 is held. The strap 500 is then pulled through the slot 125 so as to reduce the size of the opening 522 until the post 710 is secured tightly to the camera assembly 100. The hole 514 that is aligned with the tang 126 is then used to secure the strap 500 in place. The tang 126 is inserted through the hole 514. A second strap 500 may be used in the same manner discussed above with the second post 720 of the head rest 700. The reverse procedure is done to remove the camera assembly 100 from the vehicle. It is contemplated that the straps 500 and the bracket 120 may be used in order to attach the camera assembly 100 to other locations within the vehicle as well. As shown the there are a number of slots 125 and holes 514 provided in order to permit the camera 100 to be mounted on variety of devices that may be separated by variable widths, such as the poles on headrests or the slats on a crib. In an alternative embodiment, one strap 500, rather than two straps 500 may be wrapped around the head portion 730 or both posts 710, 720 of the head rest. For example, the loop 516 could extend from the first flange 122 to the second flange 123, rather than being positioned on only the first flange 122. Thus, the head rest 730 could fit in the opening 522 formed by the strap 500. In another alternative embodiment, other means of securing the strap 500 in place aside from the tangs 126 may be used. For example, the two straps 500 could connect with each other as a belt, or a loop-and-tape mechanism may be used.

Now turning to FIG. 11, where a view of the display device 200 mounted within a passenger compartment of a vehicle, in accordance with the embodiment of FIG. 1 is shown. When being mounted within a vehicle, the display device 200 may be placed on or near the dashboard of the vehicle. When placed in that location the stand 400 may be used in order to assist in the placement of the display device 200. The stand 400 may be attached to the dashboard in the vehicle using adhesive tape or some other means for mounting, such as glue, screws, etc. It is also contemplated that the display device 200 may be mounted without the stand 400, and could be attached directly to the visor of a vehicle or beneath the rear view mirror. In these embodiments the display device 200 may utilize batteries, or other power sources in lieu of the 12 V adapter 600 that is plugged into a vehicle's standard cigarette lighter. Also shown in FIG. 6 is how the 12 V adapter 600 is attached to the stand 400 and inserted into the display device 200.

FIG. 12A is a view of the camera assembly 100 mounted on a crib 800 in accordance with one embodiment of the present invention. The crib 800 is in a first room of a home, where the child to be monitored is located. In the embodiment shown, the camera 100 is attached using the bracket 120, the slots 125 and the straps 500 in order to mount the camera 100 to the posts 810 of the crib 800. Alternatively, the camera portion 110 of the camera assembly 100 may be removed from the bracket 120 and the camera portion 110 may rest on a surface in the first room, such as a bookshelf, dresser, floor, shelf, and the like. FIG. 12B is a view of the display device 200 mounted within a base unit 300 and placed in a second room within the home. The placement of the base unit 300 is typically within a different room of the house from that in which the camera assembly 100 is located and permits the monitoring of the child from a remote location.

As shown in the monitoring system 1000 shown in FIGS. 9 and 12A, the camera assembly 100 is mounted at the location where the child will be. The camera assembly 100 may be adjusted so that it is directed at the child that will be monitored. The camera assembly 100 may receive both audio and image data. Because of the infrared LED lamps 111 placed upon the housing 108, the camera assembly 100 is able to receive image data even when the surrounding environment is poorly illuminated or dark. The display device 200 is then positioned within the base unit 300 if located within a home, or placed upon the stand 400 if being used within a vehicle or directly on the dashboard, visor, etc. of the vehicle. The necessary adapters are used in order to provide power to the display device 200. During operation of the monitoring system 1000, image and audio signals are perceived by the camera assembly 100 and transmitted to the display device 200 and/or the base unit 300. The display device 200 will show the images contained from the image signals. The display device 200 will also reproduce the received audio signals and/or the base unit 300 will reproduce the audio signals.

Referring now to FIGS. 9, 11, 12A and 12B, the portability of the monitoring system 1000 will be discussed. When used in the vehicle, the monitoring system 1000 will be installed in the vehicle as shown in FIGS. 9 and 11 and described above. To move the monitoring system from the vehicle into the home, the bracket 120 may remain attached to the vehicle as shown in FIG. 9 and the camera portion 110 may be removed from the vehicle and placed in a first room. Alternatively, the entire camera assembly 100 may be removed from the vehicle and attached to the crib as shown in FIG. 12 A. Similarly, the display device 200 may be inserted in the stand 400 when the monitoring system is to be used in the vehicle. When the monitoring system is to be used in the home, the display device 200 will be removed from the stand 400 and placed within the base unit 300 as shown in FIG. 12B. The reverse procedure is performed when moving the monitoring system from the home to the vehicle. Thus, the same display device 200 and camera assembly 100 can be easily moved from a vehicle to a home and vice versa.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A portable system for observing a person comprising:
an adjustable strap;
a camera assembly comprising: (i) a camera adapted to produce an image signal corresponding to a perceived image, (ii) a bracket having at least one slot for operably receiving the adjustable strap so that the adjustable strap forms a loop, and (iii) a transmitter for wirelessly transmitting the image signal;
a display device comprising: (i) a receiver for receiving the wirelessly transmitted image signal, and (ii) means for converting the received image signal into a display image that is displayed on the display device;
a stand adapted to support the display device; and
a base unit adapted to receive the display device, the base unit having means for supplying power to the display device.

2. The system of claim 1 wherein the stand comprises:
a base structure;
a support structure adapted to support the display device, the support structure pivotably connected to the base structure; and
means for securing the stand to a surface within a passenger compartment of a vehicle.

3. The system of claim 1 wherein the stand comprises:
a base structure adapted to secure the stand to a surface within a passenger compartment of a vehicle;
a support structure having a front wall, a rear wall, a cavity between the front wall and the rear wall and an open top end forming a passageway into the cavity, the passageway dimensioned so that the display device can be slidably inserted into the cavity through the passageway; and
a cutout in the front wall, the cutout dimensioned and configured to allow unobstructed viewing of a display screen of the display device when the display device is positioned in the cavity and supported by the support structure.

4. The system of claim 1, wherein the base unit comprises:
a bay adapted to support the display device; and
a socket for receiving a 110 V adapter.

5. The system of claim 4 wherein the base unit further comprises a speaker for providing audio.

6. The system of claim 5, wherein the base unit further comprises a volume control button.

7. The system of claim 1, wherein the camera is pivotably connected to the bracket so as to pivot about both an axis substantially parallel with a longitudinal axis of the bracket and an axis perpendicular to the longitudinal axis of the bracket.

8. The system of claim 1, wherein the camera further comprises a lens and at least one infrared led.

9. The system of claim 8, comprising a plurality of the infrared leds positioned proximate to the lens.

10. The system of claim 9, wherein the plurality of infrared leds are positioned in an annular pattern surrounding the leds.

11. The system of claim 1, wherein the display device and the camera each have a port for operably receiving a 12 V adapter.

12. The system of claim 1 wherein the camera is removably connected to the bracket.

13. The system of claim 1 wherein the bracket comprises:
a first flange having a first slot;
a second flange having a second slot;
wherein the first and second slots are configured and spaced from one another so as to facilitate attachment to a vehicle's head rest support using the adjustable strap; and
wherein the camera is located between the first and second slots.

14. The system of claim 1 wherein the bracket comprises:
a first flange having a first plurality of slots;
a second flange having a second plurality of slots;
wherein the camera is located between the first and second plurality of slots; and
wherein each of the first and second plurality of slots are spaced from one another so as to facilitate attachment to a first post and a second post by sliding a first strap through any one slot of the first plurality of slots and a second strap through any one slot of the second set of slots, the first strap adapted to connect to a first locking tang and the second strap adapted to connect to a second locking tang.

15. The system of claim 1 wherein the bracket comprises:
a first flange comprising a slot;
a second flange comprising a locking tang;
wherein. the camera is positioned between the slot and the locking tang; and
wherein the strap extends through the slot to the locking tang.

16. The system of claim 1 wherein the strap comprises a first end having a stopper and a second end having a plurality of holes.

17. The system of claim 16 wherein the camera assembly further comprises a locking mechanism for locking the strap and wherein the adjustable strap is inserted through the slot so that the stopper is in contact with the bracket and the locking mechanism is inserted through one of the plurality of holes.

18. A portable system for observing a person comprising:
an adjustable strap comprising a first end having a stopper and a second end having a plurality of holes;
a camera assembly comprising: (i) a camera adapted to produce an image signal corresponding to a perceived image, (ii) a bracket having at least one slot for operably receiving the adjustable strap so that the adjustable strap forms a loop, (iii) a locking mechanism for locking the strap, and (iv) a transmitter for wirelessly transmitting the image signal;
wherein the adjustable strap is inserted through the slot so that the stopper is in contact with the bracket and the locking mechanism is inserted through one of the plurality of holes;
a display device comprising: (i) a receiver for receiving the wirelessly transmitted image signal, and (ii) means for converting the received image signal into a display image that is displayed on the display device;
a stand adapted to support the display device; and
a base unit adapted to receive the display device, the base unit having means for supplying power to the display device.
